(19) United States
(12) Patent Application Publication
(10) Pub. No.: US 2008/0298486 A1
(43) Pub. Date: Dec. 4, 2008

(54) MULTI-CELL INTERFERENCE MITIGATION VIA COORDINATED SCHEDULING AND POWER ALLOCATION IN DOWNLINK ODMA NETWORKS

(75) Inventors: LUCA VENTURINO, CASSINO (FR) (IT); NARAYAN PRASAD, MONMOUTH JUNCTION, NJ (US); XIAODONG WANG, NEW YORK, NY (US); MOHAMMAD MADIHIAN, PLAINSBORO, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/048,440

(22) Filed: Mar. 14, 2008

Related U.S. Application Data
(60) Provisional application No. 60/941,713, filed on Jun. 4, 2007.

(51) Int. Cl. H04L 27/28

(52) U.S. Cl. 375/260

(57) ABSTRACT

A multi-cell Orthogonal Frequency-Division Multiple Access (OFDMA) based wireless system and method with full spectral reuse co-channel interference mitigation via base station coordination in a downlink channel includes a plurality of base stations configured to handle communications with mobile units. A central controller is configured to mitigate interference between base stations via jointly optimizing coordinated scheduling and power allocation in accordance with a sub-optimal iterative solution. Five methods provide the solution, which include: 1) Improved Iterative Water-Filling (I-IWF); 2) Iterative Spectrum Balancing (ISB); 3) Successive Convex Approximation for Low-complexity (SCALE); 4) Opportunistic Base Station Selection (OBSS) and 5) Per-tone binary power control (PT-BPC).

### RELATED APPLICATION INFORMATION

This application claims priority to provisional application Ser. No. 60/941,713 filed on Jun. 4, 2007 incorporated herein by reference.

### BACKGROUND

1. Technical Field

The present invention relates to wireless network signal coverage, and more particularly to systems and methods for co-channel interference mitigation and power allocation in wireless systems.

2. Description of the Related Art

A wireless cellular system consists of several access points or base stations, each providing signal coverage to a small area called a cell. Each base station controls multiple users that share a same spectral resource through some multiple-access scheme. Among the others, Orthogonal Frequency-Division Multiple Access (OFDMA) is the preferred air interface of many current systems and is also a strong candidate for the next generation of cellular networks. OFDMA converts the wideband channel into narrowband subcarriers and assigns each orthogonal tone to a different user according to some scheduling policy.

Since in-cell multi-user interference and inter-symbol interference are avoided, the receiver design is simplified. On the other hand, co-channel interference caused by transmission in neighboring cells remains a major impairment that limits throughput. Current wireless networks mitigate inter-cell interference by locating co-channel base stations as far apart as possible via frequency reuse planning at the cost of lowering spectral efficiency. Future network evolutions are envisioned to employ a full (or an aggressive) frequency reuse and proactive inter-cell interference mitigation techniques are required.

Advanced multi-user detection can improve system performance. This solution is appealing in the uplink channel wherein multiple receive antennas are usually available at the base station and spatial processing may be used to null out interference. In the downlink, however, multiple receive antennas are not likely to be present and only limited signal processing capabilities are available on a mobile device due to cost and battery-life constraints. On the other hand, the downlink channel is expected to be the bottleneck of future wireless systems and, therefore, alternative solutions which move the interference mitigation/cancellation burden from the receiver to the transmitter should be investigated.

Recently, base station coordination has emerged as a means to mitigate downlink co-channel interference. Ideally, if data, timing and channel state information of all users could be shared in real-time, adjacent base stations could act as a large distributed antenna array and could employ joint beam-forming, scheduling and data encoding to simultaneously serve multiple co-channel users. However, a much lower level of coordination may be assumed in practice, depending on the bandwidth of the backbone network connecting the access points. Also, synchronization requirements actually limit the number of coordinating base stations.

### SUMMARY

In accordance with present embodiments, focus is on the downlink of a multi-cell OFDMA network wherein user data symbols are known only by the reference access point, and joint scheduling and spectrum balancing strategies are investigated among a set of coordinating cells based on channel quality measurements.

We cast the joint scheduling and spectrum balancing problem as a constrained non-convex optimization. An objective (utility) function to be maximized is the weighted system sum-rate subject to per-base station power constraints. Here, the weights account for possibly different priorities of the users. Five methods are provided to solve this problem which include: 1) Improved Iterative Water-Filling (I-IWF); 2) Iterative Spectrum Balancing (ISB); 3) Successive Convex Approximation for Low-complexity (SCALE); 4) Opportunistic Base Station Selection (OBSS) and Per-tone binary power control (PT-BPC).

A multi-cell Orthogonal Frequency-Division Multiple Access (OFDMA) based wireless system and method with full spectral reuse co-channel interference mitigation via base station coordination in a downlink channel includes a plurality of base stations configured to handle communications with mobile units. A central controller is configured to mitigate interference between base stations via jointly optimizing coordinated scheduling and power allocation in accordance with a sub-optimal iterative solution.

These and other features and advantages will become apparent from the following detailed description of illustrative embodiments thereof, which is to be read in connection with the accompanying drawings

### BRIEF DESCRIPTION OF DRAWINGS

The disclosure will provide details in the following description of preferred embodiments with reference to the following figures wherein:

FIG. 1 is a block diagram showing a system employed for interference mitigation in accordance with one illustrative embodiment;

FIG. 2 is a diagram showing a cell configuration employed in collecting simulation data;

FIG. 3 depicts graphs of weighted sum-rate versus number of iterations for various methods of determining initial parameters (e.g., PT-PBC power allocation, uniform power allocation, and random power allocation) for the I-IWF method;

FIG. 4 depicts graphs of weighted sum-rate versus number of iterations for various methods of determining initial parameters (e.g., PT-PBC power allocation, uniform power allocation, and random power allocation) for the I-ISB method;

FIG. 5 depicts graphs of weighted sum-rate versus number of iterations for various methods of determining initial parameters (e.g., PT-PBC power allocation, uniform power allocation, and random power allocation) for the I-SCALE method;

FIGS. 6-9 depict graphs comparing the present methods and conventional methods for different parameter combinations; and

FIG. 10 is a block/flow diagram showing a system/method for jointly optimizing power allocation and scheduling using suboptimal iterative solutions in accordance with the present principles.

### DETAILED DESCRIPTION OF PREFERRED EMBODIMENTS

The present embodiments present efficient solutions for the coordinated scheduling and spectrum balancing problem which overcome the limitations of previous related works. Also, reduced-feedback implementations for all presented strategies are provided.

We consider a multi-cell OFDMA-based wireless network with full spectral reuse, and we study the problem of co-channel interference mitigation via base station coordination in the downlink channel. Assuming that the cluster of coordinated base stations can only share channel quality measurements in real time, the present invention provides efficient methods which jointly optimize a set of co-channel users scheduled on each tone and the power allocation at each base station. An objective (utility) function to be maximized is a weighted system sum-rate subject to per-base station peak power constraints:

$${max}_{{{p}_{m}^{[ n ]} \geq 0}_{k ( m , n ) ∈ {B}_{m}}} {\sum }_{m = 1}^{M} {\sum }_{n = 1}^{N} {w}_{k ( m , n )} {log}_{2} ( 1 + \frac{{P}_{m}^{[ n ]} {G}_{m , k ( m , n )}^{[ n ]}}{1 + {\sum }_{j = 1 , j \neq m}^{M} {P}_{j}^{[ n ]} {G}_{j , k ( m , n )}^{[ n ]}} ) , \\ subject to {\sum }_{n = 1}^{N} {P}_{m}^{[ n ]} \leq {P}_{m , max} \cdot ∀ m , \qquad ( 1 A )$$

where N is the number of tones; M is the number of coordinated base stations; Pₘ^{[n]} is the power allocated on tone n by base station m; k(m,n) is the user scheduled by base station m on tone n; wₛ≧0 is the weight associated with user s; Bₘ is the set of users served by base station m; finally, G_{m,s}^{[n]} is the normalized (with respect to the noise power) channel gain between base station m and user s.

PROBLEM STATEMENT: We consider a cluster of M≧2 coordinated access points in a downlink OFDMA cellular network employing N orthogonal subcarriers and full frequency reuse across cells. We assume that users and base stations are equipped with one receive and one transmit antenna, respectively. Each user is connected to only one reference base station which is selected based on long-term channel quality measurements, i.e., soft hand-off is not permitted. We denote by Bₘ the set of users assigned to base station m and define S≡B₁∪ . . . ∪B_{M}. Assuming that |Bₘ=|Kₘ, we have |S|≦MK with K≡max{K₁, . . . , K_{M}}. We also consider an infinitely backlogged model wherein each access point always has data available for transmission to all connected users.

Let user s be connected to base station m on tone n. Assuming perfect synchronization, the discrete-time baseband signal received by user s on tone n is given by

$${r}_{s}^{[ n ]} = \underbrace{{H}_{m , s}^{[ n ]} {x}_{m}^{[ n ]}}_{useful data} + \underbrace{{\sum }_{j = 1 , j \neq m}^{M} {H}_{j , s}^{[ n ]} {x}_{j}^{[ n ]}}_{other cell interference} + \underbrace{{n}_{s}^{[ n ]}}_{noise} , \qquad ( 2 A )$$

where H_{m,s}^{[n]} is the complex fading channel response between base station m and user s at tone n; xₘ^{[n]} the complex symbol transmitted by base station m on tone n. Let E{xₘ^{[n]}|²}=pₘ^{[n]}≧0 and let P_{m,max} be the total power constraint of base station m. We require that

$${\sum }_{n = 1}^{N} {p}_{m}^{[ n ]} \leq {P}_{m , max}$$

for m=1, . . . , M; nₛ^{[n]} is the additive noise, which is modeled as a circularly-symmetric complex Gaussian random variable with variance Nₛ^{[n]}/2 per real dimension. Considering different noise levels at each mobile terminal accounts for the different levels of interference received from other uncoordinated co-channel sources and, possibly, for the different noise figures of the receivers.

If the symbols transmitted by the M base stations are independent, the signal-to-interference-plus-noise ratio (SINR) for user s, if connected to base station m on tone n, is written

$$as SIN {R}_{m , s}^{[ n ]} ( {p}^{[ n ]} ) ≡ \frac{{p}_{m}^{[ n ]} {G}_{m , s}^{[ n ]}}{1 + {\sum }_{j = 1}^{M} {p}_{j}^{[ n ]} {G}_{j , s}^{[ n ]}} \qquad ( 3 A )$$

with G_{m,s}^{[n]}≡|H_{m,s}^{[n]}|²/Nₛ^{[n]} and p^{[n]}≡(p₁^{[n]}, . . . , p_{M}^{[n]})^{T}; also, the corresponding achievable information rate (in bits/channel-use) is

Rₘ^{[n]}(p^{[n]})=log₂[1+SINR_{m,s}^{[n]}(p^{[n]})]. (4A)

For given values of the normalized channel gains {G_{m,s}^{[n]}}, the set of coordinated base stations can mitigate inter-cell interference and improve system performance by jointly optimizing 1) the power allocation across the N orthogonal subcarriers and 2) the set of co-channel users which are scheduled on each tone. Here, we propose to compute the optimal power distribution and scheduling decision so as to maximize a weighted system sum-rate subject to per base station power constraints. Indicate with k(m,n)εBₘ the user scheduled by base station m on tone n and define the set of co-channel users scheduled on tone n as k^{[n]}≡(k(1, n), . . . , k(M,n))^{T}εB with B≡B₁x . . . xB_{M}. Let p≡vec{p^{[1]}, . . . , p^{[N]}} and k≡vec{k^{[1]}, . . . , k^{[N]}}εK, with K≡B^{N}. The problem to be solved is the following:

$${max}_{{p \geq 0}_{k ∈ K}} {\sum }_{m = 1}^{M} {\sum }_{n = 1}^{N} {w}_{k ( m , n )} {R}_{m , k ( m , n )}^{[ n ]} ( {p}^{[ n ]} ) \qquad ( 5 A )$$

Subject to

$${\sum }_{n = 1}^{N} {p}_{m}^{[ n ]} \leq {P}_{m , max} ,$$

∀m where wₛ≧0 is a weight accounting for the priority of user s, normalized such that

$${\sum }_{s ∈ S} {w}_{s} = \vert S \vert / ( NM ) .$$

Solving (5A) needs knowledge of {G_{m,s}^{[n]}} and {wₛ} and therefore implies some information sharing among the coordinating access points. Also, notice that (5A) is a constrained non-convex optimization; hence, computing its exact solution is an NP-hard problem. One objective of this work is to derive and discuss lower complexity methods to compute suboptimal solutions to (5A) for any given set of channel gain {G_{m,s}^{[n]}} and users' weights {wₛ}.

Discussing actual policies to assign and update the users' weights is outside the scope of this disclosure. However, if wₛ=1/(NM), the objective function in (5A) becomes the per-cell throughput (measured in bits/channel-use/subcarrier/cell); more generally, the coefficients {wₛ} may be adjusted over time to maintain some fairness among terminals. For any given choice of {wₛ}, we provide operative solutions to jointly optimize the power allocation and the scheduling decision at each coordinated base station.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

Joint scheduling and spectrum balancing among a set of coordinated base stations uses additional feedback information from mobile terminals with respect to uncoordinated strategies. Indeed, each terminal has to track and report not only the quality of the channel from the reference access point, but also the quality of the channels from the other coordinated base stations. However, we show that this additional feedback may be made small as follows: (a) Since adjacent tones are highly correlated, they are usually grouped in P resource blocks, each one including N_{b}=TN/P consecutive tones; hence, only a set of channel quality measurements per each resource block has to be fed back. (b) Moreover, per-user feedback may be further reduced by notifying to the reference base station the quality of only the best Q (with Q<<P) resource blocks: indeed, each user is likely to be scheduled only on those tones where a larger throughput can be achieved. (c) Finally, not all users have to report back full channel state information.

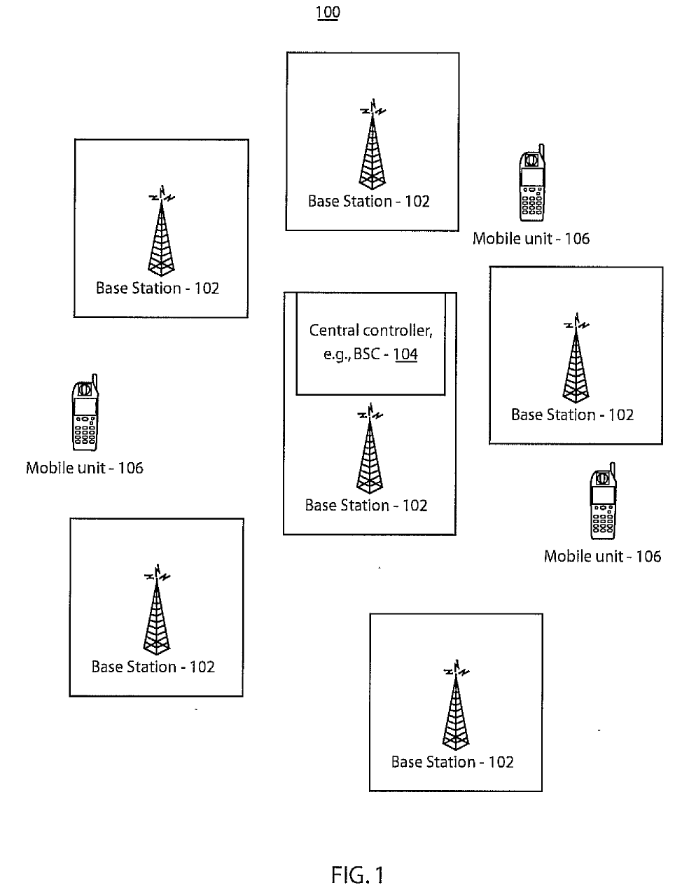

Referring now to the drawings in which like numerals represent the same or similar elements and initially to FIG. 1, a system 100 includes a wireless system. System 100 includes a central control unit 104, which collects channel quality measurements and runs the proposed methods in accordance with the present principles. Mobile units 106 communicate wirelessly with the base stations 102. The mobile units 106 may include any number of wireless device types, including cell phones, wireless laptop, personal digital assistants (PDAs), sensors, etc. However, in current network infrastructures groups of adjacent base stations 102 are already connected to a common Base Station Controller (BSC): therefore, it appears natural to implement the present methods at the BSC level, without affecting the remaining network structure. The central controller 104 is equipped with hardware and/or software capable of carrying out the joint optimization methods, which will be described hereinafter.

The present principles provide five methods for coordinated scheduling and spectrum balancing. These include:

1. Opportunistic base station selection (OBSS)—While accounting for the priority of the users, this method tries to assign each tone to the user with the best channel quality among all base stations in solving Eq. (1A). Also, after per-tone user selection, each base station optimally splits the available power across the set of active subcarriers. Implementing this method requires that each user feeds back one channel quality measurement per resource block. The method is listed in Table I.

TABLE I
OPPORTUNISTIC BASE STATION SELECTION (OBSS)

1: Set Dₘ = {} and Pₘ^{[n]} = P_{m,max}/N for m = 1, . . . , M and
n = 1, . . . , N.
2: for n = 1 to N do
3: Select user and base station on tone n:

$\hat{k} ( m , n ) = arg {\underbrace{{max}_{s ∈ {B}_{m}} [ {w}_{s} {log}_{2} ( 1 + {P}_{m}^{[ n ]} {G}_{m , s}^{[ n ]} ) ]} ,}_{{\text{?}}_{m}^{[ n ]}} m = 1 , . . . , M . \\ \text{?} \text{indicates text missing or illegible when filed}$
$\hat{m} = arg {max}_{\text{?} ∈ \{ 1 , . . . \text{?} M \}} {\hat{R}}_{s}^{[ n ]} : {D}_{\text{?}} = {D}_{\text{?}} ⋃ \{ n \} . \\ \text{?} \text{indicates text missing or illegible when filed}$

4: end for
5: Optimize the power allocation across the active tones:

$\{ \begin{matrix}{\hat{P}}_{m}^{[ n ]} = 0 , ∀ n ∉ {D}_{m} , \\ {\hat{P}}_{m}^{[ n ]} = {( \frac{{w}_{\hat{k} ( m , n )}}{λ} - \frac{1}{{G}_{m , \text{?} ( m , n )}^{[ n ]}} )}^{+} , ∀ n ∈ {D}_{m} , \\ {\sum }_{n ∈ {D}_{m}} {( \frac{{w}_{\text{?} ( m , n )}}{λ} - \frac{1}{{G}_{m , \text{?} ( m , n )}^{[ n ]}} )}^{+} = {P}_{m . max .}\end{matrix} \\ \text{?} \text{indicates text missing or illegible when filed}$

2. Per-tone binary power control (PT-BPC)—This method solves the non-convex problem of Eq. (1A) by assuming that base stations equally split the available power across tones. Also, each base station is permitted to be either silent or transmitting at full power on each tone. Implementing PT-BPC requires that each user sends back M channel quality measurements per resource block. A reduced-complexity version of PT-BPC (RC-PT-BPC) is also provided wherein we restrict the optimization set to include only M+1 activation patterns corresponding to the cases where all base stations are simultaneously active or any of the M access points is active alone: in this latter case, a two-rate feedback suffices to implement the method, independently of M. The method is listed in TABLE II.

PT-BPC extends the idea of binary power control to a wideband OFDMA multi-cell multi-user system. Also, RC-PT-BPC is a novel implementation.

TABLE II
PER-TONE BINARY POWER CONTROL (PT-BPC) - REDUCED-COMPLEXITY PT-BPC (RC-PT-BPC)

1: Set Pₘ^{[n]} = P_{m,max}/N for m = 1, . . . , M and n = 1, . . . , N.
2: for n = 1 to N do
3: Compute \hat{d} = [\hat{d}₁, . . . , \hat{d}_{M}]^{T} as in (3)-(5)
4: Compute scheduling decisions and power allocation as follows

| | |
|---|---|
| \hat{P}ₘ^{[n]} = Pₘ^{[n]}\hat{d}ₘ, for m = 1, . . . , M, | (1) |
| $\hat{k} ( m , n ) = arg {max}_{\text{?} ∈ {B}_{m}} {w}_{s} {log}_{2} ( 1 + \frac{{\hat{d}}_{m} {P}_{m}^{[ n ]} {G}_{m , s}^{[ n ]}}{1 + {\sum }_{j = 1 , j \neq m}^{M} {\hat{d}}_{j} {P}_{j}^{[ n ]} {G}_{j , s}^{[ n ]}} ) , if {\hat{d}}_{m} \neq 0.$ $\text{?} \text{indicates text missing or illegible when filed}$ | (2) |

5: end for

| | |
|---|---|
| $\hat{d} = {[ {\text{?}}_{1 , . . . ,} {\hat{d}}_{M} ]}^{T} = arg {max}_{\text{?} ∈ D} {\sum }_{m = 1}^{M} {w}_{k ( d . m . n )} {log}_{2} ( 1 + \frac{{d}_{m} {P}_{m}^{[ n ]} {G}_{m . k ( d , m , n )}^{[ n ]}}{1 + {\sum }_{j = 1 , j \neq m}^{M} {d}_{j} {P}_{j}^{[ n ]} {G}_{j . k ( d , m , n )}^{[ n ]}} ) , \\ \text{?} \text{indicates text missing or illegible when filed}$ | (3) |
| $k ( d , m , n ) = arg {max}_{∈ {B}_{m}} {w}_{s} {log}_{2} ( 1 + \frac{{d}_{m} {P}_{m}^{[ n ]} {G}_{m . s}^{[ n ]}}{1 + {\sum }_{j = 1. j \neq m}^{M} {d}_{j} {P}_{j}^{[ n ]} {G}_{j . s}^{[ n ]}} ) , if {d}_{m} \neq 0.$ | (4) |
| $D = \{ \begin{matrix}{[ 0 , 1 ]}^{M} & for PT \text{-} BPC \\ \{ {( 1 , 0 , . . . , 0 )}^{T} , {( 0.1 , 0 . . . , 0 )}^{T} , . . . , {( 0 , . . . , 0.1 )}^{T} , {( 1 , . . . , 1 )}^{T} \} & for RC \text{-} PT \text{-} BPC\end{matrix} .$ | (5) |

3. Improved iterative water-filling (I-IWF)—This method finds a local optimal solution of Eq. (1A) by iteratively solving the Karush-Kuhn-Tucker (KKT) system. The procedure resembles a modified water-filling method wherein more power is allocated on tones which serve users with either higher priority or better channel gains. Also, the power is carefully balanced to avoid excessive interference to other-cell scheduled users. The method is listed in TABLE III. Implementing I-IWF requires that each user sends back M channel quality measurements per resource block.

To limit signaling overhead, we provide in TABLE VI, a reduced-feedback version of I-IWF (I-IWF-RF) wherein only a subset of users is requested to report full channel state information. In particular, if K is the number of users per-cell, I-IWF-RF just needs knowledge of NK+N(M−1) channel quality measurements per-cell (which compares favorably to the NMK channel quality measurements per-cell needed by I-IWF and PT-BPC).

The I-IWF method provides a user scheduling step at lines 2 and 9 in Table III, which accounts for the presence of multiple users at each base station. I-IWF-RF is a novel implementation.

TABLE III
IMPROVED ITERATIVE WATER-FILLING (I-IWF)

```
  1: Initialize Lₘₐₓ and set l = 0
  2: Initialize {Pₘ^{[n]}}
  3: Compute the initial values of {k(m, n)} according to (6)
  4: Compute the initial values of {tₘ^{[n]}} according to (7)
  5: repeat
  6: repeat
  7: for m = 1 to M do
  8: Update Pₘ^{[} [symbol] ^{]} . . . , Pₘ^{[N]} according to (8)
  9: end for
10: Update {k(m, n)} according to (6)
11: until all {Pₘ^{[n]}} and {k(m, n)} converge
12: Update {tₘ^{[n]}} according to (7) and set l = l + 1
13: until all {tₘ^{[n]}} converge or l > Lₘₐₓ
```

| $k ( m , n ) = arg {max}_{\text{?} ∈ {B}_{m}} [ {w}_{\text{?}} {log}_{2} ( 1 + \frac{{P}_{j}^{[ n ]} {G}_{m , \text{?}}^{[ n ]}}{{\sum }_{j = 1 , j \neq m}^{M} {P}_{j}^{[ n ]} {G}_{j , s}^{[ n ]} + 1} ) ] , \\ \text{?} \text{indicates text missing or illegible when filed}$ | (6) |
|---|---|
| | (7) |

${t}_{m}^{[ n ]} = {\sum }_{j = 1 , j \neq m}^{M} \frac{{w}_{k ( j , n )} {P}_{j}^{[ n ]} {G}_{j . k ( j , n )}^{[ n ]} {G}_{m , k ( j , n )}^{[ n ]}}{( 1 + {\sum }_{\text{?} = 1}^{M} {P}_{\text{?}}^{[ n ]} {G}_{\text{?} . k ( j , n )}^{[ n ]} ) ( 1 + {\sum }_{\text{?} = 1 , \text{?} \neq j}^{M} {P}_{\text{?}}^{[ n ]} {G}_{\text{?} . k ( j , n )}^{[ n ]} )} , \\ \text{?} \text{indicates text missing or illegible when filed}$

| | |
|---|---|
| $\{ \begin{matrix}{P}_{m}^{[ n ]} = {( \frac{{w}_{k ( m , n )}}{{λ}_{m} + {t}_{m}^{[ n ]}} - \frac{1 + {\sum }_{j = 1 , j \neq m}^{M} {P}_{j}^{[ n ]} {G}_{j , k ( m , n )}^{[ n ]}}{{G}_{m , k ( m , n )}^{[ n ]}} )}^{+} , \\ {P}_{m . max} \geq {\sum }_{n = 1}^{N} {( \frac{{w}_{k ( m , n )}}{{λ}_{m} + {t}_{m}^{[ n ]}} - \frac{1 + {\sum }_{j = 1 , j \neq m}^{M} {P}_{j}^{[ n ]} {G}_{j , k ( m . n )}^{[ n ]}}{{G}_{m . k ( m , n )}^{[ n ]}} )}^{+} .\end{matrix}$ | (8) |

[symbol]

indicates data missing or illegible when filed

4. Iterative spectrum balancing (ISB)—The method solves Eq. (1A) in the Lagrange dual domain by iteratively optimizing power allocation, user selection and Lagrangian dual prices. The procedure is listed in TABLE IV. Implementing ISB requires that each user sends back M channel gains per resource block. Nevertheless, a reduced-feedback version of ISB (ISB-RF) can be derived along the same lines of I-IWF-RF. The ISB method provides a user scheduling step at lines 2 and 10 in Table IV, which accounts for the presence of multiple users at each base station. ISB-RF is a novel implementation.

TABLE IV
ITERATIVE SPECTRUM BALANCING (ISB)

```
  1: Initialize Lₘₐₓ and set l = 0
  2: Initialize {\hat{P}ₘ^{[n]}}
  3: Compute the initial values of {\hat{k}(m, n)} according to (9)
  4: initialize λ according to (11)
  5: repeat
  6: for n = 1 to N do
  7: repeat
  8: for m = 1 to M do
  9: Update \hat{P}ₘ^{[n]} according to (10)
10: end for
11: Update \hat{k}(1, n), . . . , \hat{k}(M, n) according to (9)
12: until all \hat{P} [symbol] ^{[n]} , . . . , \hat{P}_{M}^{[n]} and \hat{k}(1, n), . . . , \hat{k}(M, n) converge
13: end for
14: Update λ according to (12) and set l = l + 1
15: until λ converges or l > Lₘₐₓ
```

| | |
|---|---|
| $\hat{k} ( m , n ) = arg {max}_{\text{?} ∈ {B}_{m}} [ {w}_{\text{?}} {log}_{2} ( 1 + \frac{{\hat{P}}_{m}^{[ n ]} {G}_{m , \text{?}}^{[ n ]}}{{\sum }_{j = 1 , j \neq m}^{M} {\hat{P}}_{j}^{[ n ]} {G}_{j , \text{?}}^{[ n ]} + 1} ) ] . \\ \text{?} \text{indicates text missing or illegible when filed}$ | (9) |
| ${\text{?}}_{m}^{[ n ]} = arg {max}_{{{P}_{m}^{[ n ]} \geq 0}_{{{P}_{\text{?}}^{[ n ]} = {P}_{\text{?}}^{[ n ]} , ∀ j \neq m}_{k ( m , n ) = k ( m , n ) , ∀ m}}} {\sum }_{m = 1}^{M} [ {w}_{k ( m . n )} {log}_{2} ( 1 + \frac{{d}_{m} {P}_{m}^{[ n ]} {G}_{m . k ( m , n )}^{[ n ]}}{1 + {\sum }_{j = 1 , j \neq m}^{M} {P}_{j}^{[ n ]} {G}_{j . k ( m , n )}^{[ n ]}} ) - {λ}_{m} {P}_{m}^{[ n ]} ] , \\ \text{?} \text{indicates text missing or illegible when filed}$ | (10) |
| $\begin{matrix}{λ}_{0} = [ \frac{{λ}_{1}^{single}}{2} {max}_{\text{?} ∈ {B}_{1}} w \text{?} {max}_{\text{?} ∈ {B}_{M}} w \text{?} ] \cdot {A}_{D}^{- 1} = M diag \{ {λ}_{0}^{2} \} , \\ ( {λ}_{M}^{single} is defined in Lemma 1 ) \\ \text{?} \text{indicates text missing or illegible when filed}\end{matrix}$ | (11) |
| ${\hat{{d}_{\text{?}}}}_{\text{?}} = \frac{d \text{?}}{\sqrt{{d}_{\text{?}}^{T} {A}_{\text{?}}^{- 1} {d}_{\text{?}}}} \cdot {λ}_{\text{?} + 1} = {( \text{?} \text{?} - \frac{1}{M + 1} {A}_{\text{?}}^{- 1} {\text{?}}_{\text{?}} )}^{+} , {A}_{\text{?} + 1}^{- 1} = \frac{{M}^{2}}{{M}^{2} - 1} ( {A}_{\text{?}}^{- 1} - \frac{2}{M + 1} {A}_{\text{?} + 1}^{- 1} {\text{?}}_{\text{?}} {\text{?}}_{\text{?}}^{T} {A}_{\text{?} + 1}^{- 1} ) . \\ \text{?} \text{indicates text missing or illegible when filed}$ | (12) |

[symbol]

indicates data missing or illegible when filed

5. Successive convex approximation for low-complexity (SCALE)—The method iteratively solves a convex relaxation of Eq. (1A) in the Lagrange dual domain. Remarkably, this strategy always produces at least a local optimal solution which satisfies the KKT system. The procedure is listed in TABLE V. Implementing SCALE requires that each user sends back M channel gains per resource block. A reduced-feedback version of SCALE (SCALE-RF) can also be derived along the same lines of I-IWF-RF.

I-IWF, ISB and SCALE (and their reduced-feedback versions) all provide similar performances and outperform all the other methods. We remark that, since I-IWF, ISB and SCALE are iterative methods, their performances may depend upon the starting point. We found that good solutions are always obtained by using as a starting point the power allocation provided by either PT-BPC or PT-PBC-RF.

SCALE includes the user scheduling step at lines 2 and 7 in Table V, which accounts for the presence of multiple users at each base station. Also, SCALE-RF is a novel implementation.

TABLE V
SUCCESSIVE CONVEX APPROXIMATION FOR LOW-COMPLEXITY (SCALE)

```
  1: Initialize Lₘₐₓ and set l = 0 and
  2: Initialize {Pₘ^{[n]}}
  3: Compute {k(m, n)} according to (13).
  4: Compute {zₘ^{[n]}} according to (14) and initialize {αₘ^{[n]}, βₘ^{[n]}} by using (15)
  5: repeat
  6: Set l = l + 1
  $7 \text{:} Solve ( 16 ) to obtain \{ {\tilde{P}}_{m}^{[ n ]} \} and compute {P}_{m}^{[ n ]} = {e}^{{\text{?}}_{\text{?}}} \\ \text{?} \text{indicates text missing or illegible when filed}$
  8: Update {k(m, n)} according to (13)
  9: Compute {zₘ^{[n]}} according to (14) and update {αₘ^{[n]}, βₘ^{[n]}} by using (15)
10: until convergence or l > Lₘₐₓ
```

| | |
|---|---|
| $k ( m , n ) = arg {max}_{\text{?} ∈ {B}_{m}} [ {w}_{\text{?}} {log}_{2} ( 1 + \frac{{P}_{j}^{[ n ]} {G}_{m , \text{?}}^{[ n ]}}{{\sum }_{j = 1 , j \neq m}^{M} {P}_{j}^{[ n ]} {G}_{j , s}^{[ n ]} + 1} ) ] , \\ \text{?} \text{indicates text missing or illegible when filed}$ | (13) |
| ${z}_{m}^{[ n ]} = \frac{{P}_{m}^{[ n ]} {G}_{m . k ( m , n )}^{[ n ]}}{1 + {\sum }_{j = 1 , j \neq m}^{M} {P}_{j}^{[ n ]} {G}_{j , k ( m . n )}^{[ n ]}} .$ | (14) |
| ${\text{?}}_{m}^{[ n ]} = \frac{{z}_{m}^{[ n ]}}{1 + {z}_{m}^{[ n ]}} , {β}_{m}^{[ n ]} = {log}_{2} ( 1 + {z}_{m}^{[ n ]} ) - \frac{{z}_{m}^{[ n ]}}{1 + {z}_{m}^{[ n ]}} {log}_{2} {z}_{m}^{[ n ]} . \\ \text{?} \text{indicates text missing or illegible when filed}$ | (15) |
| $\{ \begin{matrix}{\text{?}}_{m}^{[ n ]} \} = arg {max}_{{\text{?}}_{m}^{[ n ]} \geq 0} { \sum }_{m = 1}^{M} {\sum }_{n = 1}^{N} {w}_{k ( m , n )} [ {α}_{m}^{[ n ]} {log}_{2} ( \frac{{e}^{{\text{?}}_{m}^{[ n ]}} {G}_{m , k ( m , n )}^{[ n ]}}{1 + {\sum }_{j = 1 , j \neq m}^{M} {e}^{{\text{?}}_{j}^{[ n ]}} {G}_{j , k ( m , n )}^{[ n ]}} ) + {β}_{m}^{[ n ]} ] \\ subject to {\sum }_{n = 1}^{N} {e}^{{\text{?}}_{m}^{[ n ]}} \leq {P}_{{m , max}_{ \text{?}}} , ∀ m .\end{matrix} \text{?} \\ \text{?} \text{indicates text missing or illegible when filed}$ | (16) |

TABLE VI
PT-BPC-RF. I-IWF-RF, ISB-RF AND SCALE-RF

```
1: In the first phase, each user s ∈ Bₘ reports to the reference access
  point m a single SINR information for each tone. At this stage, the
  reported SINR's are computed by suboptimally assuming a uniform
  power allocation at each access point, i.e.,
```

${\overline{SINR}}_{s}^{[ n ]} = \frac{{P}_{m , max} {G}_{m , s}^{[ n ]}}{N + {\sum }_{j = 1 , j \neq m}^{M} {P}_{j , max} {G}_{j , s}^{[ n ]}} , n = 1 , . . . , N .$

```
  Relying on { S̅I̅N̅R̅ₛ^{[n]}}, each access point m = 1, . . . , M independently
  makes its user selection as follows
```

| | |
|---|---|
| $\overline{k} ( m , n ) = arg {max}_{∈ {B}_{m}} {w}_{} {log}_{2} ( 1 + {\overline{SINR}}_{s}^{[ n ]} ) , n = 1 , . . . , N .$ | (17) |

```
2: In the second phase, each access point m requests user k̅(m,n) selected
  $on tone n to provide {G}_{1. \overline{k} ( m , n )}^{[ n ]} , . . . , {G}_{M , \overline{k} ( m , n )}^{[ n ]} to the central controller .$
  At this point, the PT-BPC or I-IWF or ISB or SCALE algorithm is
  employed to optimize the power allocation for the given scheduling
  decision { k̅(m, n)}.
```

COORDINATED SCHEDULING AND POWER ALLOCATION: We present three iterative strategies for coordinated scheduling and power allocation when complete channel state information is available. All proposed solutions are centralized (i.e., they require a central control unit (104, FIG. 1) that collects and processes the channel quality measurements and the users' weights).

Improved iterative water-filling (I-IWF): In order to solve Eq. (5A), notice first that for any feasible p the solution to

$${max}_{k ∈ K} {\sum }_{m = 1}^{M} {\sum }_{n = 1}^{N} {w}_{k ( m , n )} {R}_{m , k ( m , n )}^{[ n ]} ( {p}^{[ n ]} ) , is \qquad ( 6 A )$$

achieved at

$$\hat{k} ( m , n ) ≡ arg {max}_{s ∈ {B}_{m}} [ {w}_{s} {R}_{m , s}^{[ n ]} ( {p}^{[ n ]} ) ] , ∀ n , m . \qquad ( 7 A )$$

On the other hand, for any given user selection kεK, the corresponding optimal set of powers must satisfy the Karush-Kuhn-Tucker (KKT) conditions, which are known in the art. In particular, let

$$Λ ( p , k , λ ) ≡ {\sum }_{m = 1}^{M} {\sum }_{n = 1}^{N} {w}_{k ( m , n )} {R}_{m , k ( m , n )}^{[ n ]} ( {p}^{[ n ]} ) + {\sum }_{m = 1}^{M} {λ}_{m} ( {P}_{m , max} - {\sum }_{n = 1}^{N} {p}_{m}^{[ n ]} ) \qquad ( 8 A )$$

be the Lagrangian of the constrained optimization problem of Eq. (5A) dualized with respect to the power constraint, where λ≡(λ₁, . . . , λ_{M})^{T} is the vector of non-negative Lagrange multipliers. By taking the derivative of (8A) with respect to pₘ^{[n]}, the optimal λ and p must satisfy the following equalities:

$$\begin{matrix}{p}_{m}^{[ n ]} + \frac{1 + {\sum }_{j = 1 , j \neq m}^{M} {p}_{j}^{[ n ]} {G}_{j , k ( m , n )}^{[ n ]}}{{G}_{m , k ( m , n )}^{[ n ]}} = \frac{{w}_{k ( m , n )}}{{λ}_{m} ln 2 + {t}_{m}^{[ n ]}} , ∀ m , n , & ( 9 A ) \\ where & \\ {t}_{m}^{[ n ]} ≡ {\sum }_{j = 1}^{M} \frac{{w}_{k ( j , n )} {G}_{m , k ( j , n )}^{[ n ]} {SINR}_{j , k ( j , n )}^{[ n ]} ( {p}^{[ n ]} )}{( 1 + {\sum }_{l = 1}^{M} {p}_{l}^{[ n ]} {G}_{l , k ( j , n )}^{[ n ]} )} . & ( 10 A )\end{matrix}$$

Using the above observations, we now present a method which computes a suboptimal solution to Eq. (5A) by iteratively solving (7A) and the corresponding KKT conditions for the powers in (9A) and (10A). Assume that the previously computed values of {\hat{p}ₘ^{[n]}}, {\hat{k}(m,n)} and {\hat{t}ₘ^{[n]}} are given. We first update the power allocation at base station 1 assuming that {\hat{k}(m,n)}, {\hat{t}ₘ^{[n]}} and the transmit power of the other access points remain fixed. Then, we optimize the power allocation at base station 2: we now use the updated values of \hat{p}₁^{[1]}, . . . , \hat{p}₁^{[N]} and again the previous values of {\hat{k}(m,n)}, {\hat{t}ₘ^{[n]}} and \hat{p}₁^{[1]}, . . . , \hat{p}₁^{[N]} for m=3, . . . , M. The power allocation of the remaining access points is similarly updated. At each base station m, the new values of \hat{p}₁^{[1}], . . . , \hat{p}₁^{[N]} are computed as the solution to the following modified water-filling system:

$$\{ \begin{matrix}{\hat{p}}_{m}^{[ n ]} = {( \frac{{w}_{\overline{k} ( m , n )}}{{λ}_{m} ln 2 + {\hat{t}}_{m}^{[ n ]}} - \frac{1 + {\sum }_{j = 1 , j \neq m}^{M} {\hat{p}}_{j}^{[ n ]} {G}_{j , k ( m , n )}^{[ n ]}}{{G}_{m , \overline{k} ( m , n )}^{[ n ]}} )}^{+} , \\ {P}_{m , max} \geq {\sum }_{n = 1}^{N} {p}_{m}^{[ n ]}\end{matrix} \qquad ( 11 A )$$

Each base station allocates more power on tones that serve users with either higher priorities or better channel qualities; also, the taxation terms {\hat{t}ₘ^{[n]}} lower the power level when transmission causes excessive interference to other-cell scheduled users. Luckily, the problem (11A) is a monotonic function of λₘ: therefore, it can be solved efficiently via bisection. If no positive value of λₘ can match the equality, then λₘ is set to zero: in this latter case, base station m does not use all of the available power.

After updating all {\hat{p}ₘ^{[n]}}, the new scheduling decision is computed as in (7A). Finally, the taxation terms {\hat{t}ₘ^{[n]}} are also updated using (10A) and the process is iterated. See a summary of the I-IWF method in TABLE III.

Implementation issues: Let T₁ be the number of iterations needed for the inner loop (which updates {\hat{p}ₘ^{[n]}} and {\hat{k}(m,n)} in TABLE III to converge, respectively. For a given value of T₁, the computational complexity of each iteration of the I-IWF is O(T₁N(|S|+M log₂(N))); indeed, the solution of each water-filling system has a computational burden O(N log₂(N)), while updating the all scheduling decisions has a complexity linear in N|S|. As typical in iterative-water-filling-like methods, the convergence of the above procedure is not easy to establish analytically, even though convergence has been always observed in our experiments. Nevertheless, suppose the algorithm converges to some p and k. Then, these obtained values must simultaneously satisfy (7A), (9A) and (10A), which are necessary conditions for the stationary points of (5A).

For the special case of K=1, the method reduces to the I-IWF procedure described for ADSL. One innovation here is the user scheduling step in (7A) which accounts for multiple users at each base station. Notice that, if the taxation terms {\hat{t}ₘ^{[n]}} are set to zero, the above procedure reduces to a conventional iterative water-filling (C-IWF) method. In this latter case, the outer loop in TABLE III is not present and base stations become selfish, i.e., they try to maximize their own throughput regardless of the amount of interference caused to other-cell users.

Iterative Spectrum Balancing (ISB): We present here an approximate solution to Eq. (5A), wherein the duality theory is applied to solve a special class of non-convex optimization problems in multi-carrier systems. The idea is to solve the primal problem (5A) in the Lagrangian dual domain. More precisely, we introduce the dual objective function g(λ), defined as

$$g ( λ ) ≡ {max}_{{p \geq 0}_{k ∈ K}} Λ ( p , k , λ ) \qquad ( 12 A )$$

where Λ(.) is given by (8A). For any λ≧0, g(λ) is an upper bound to the solution of the primal problem. The dual optimization is to find the value of λ that provides the best bound, namely

$$arg {min}_{λ \geq 0} g ( λ ) . \qquad ( 13 A )$$

Let \hat{λ} be the solution to (13A). The difference between g(\hat{λ}) and the solution to the primal problem (5A) is called the duality gap. Notice now that (5A) belongs to the special class of non-convex optimization problems for which the time sharing property holds and hence the duality gap is zero as N→∞. If the duality gap is zero, the optimal power allocation \hat{p} and user scheduling strategy \hat{k} are given by

$$arg {max}_{{p \geq 0}_{k ∈ K}} Λ ( p , k , λ ) . \qquad ( 14 A )$$

Notice that (14A) may have multiple solutions and some of them may not be feasible. If the duality gap is zero, at least one solution is guaranteed to be feasible.

Solving (14A) involves two steps which are now discussed: a) first, (12A) is solved for a given λ; b) then, the dual optimization (13A) is performed. The complete ISB method is listed in TABLE IV.

Step a)—We observe that (12A) can be recast as follows:

$$g ( λ ) = {max}_{{{p}^{[ n ]} \geq 0}_{{k}^{[ n ]} ∈ B}} {\sum }_{n = 1}^{N} {g}_{n} ( {p}^{[ n ]} , {k}^{[ n ]} , λ ) + {\sum }_{m = 1}^{M} {λ}_{m} {P}_{m , max} , \\ where \\ {g}_{n} ( {p}^{[ n ]} , {k}^{[ n ]} , λ ) ≡ {\sum }_{m = 1}^{M} [ {w}_{k ( m , n )} {R}_{m , k ( m , n )}^{[ n ]} ( {p}^{[ n ]} ) - {λ}_{m} {p}_{m}^{[ n ]} ] . \qquad ( 15 A )$$

The maximization problem (15A) can now be decomposed into N smaller per-tone subproblems:

$${max}_{{{p}^{[ n ]} \geq 0}_{{k}^{[ n ]} ∈ B}} {g}_{n} ( {p}^{[ n ]} , {k}^{[ n ]} , λ ) , n = 1 , … , N \qquad ( 16 A )$$

Ruling out the possibility of optimally solving the multivariate optimization (16A) due to its non-convex structure, we propose to find a local optimal solution via a coordinate ascent search. To be more precise, let \hat{p}^{[n]} and \hat{k}^{[n]} be the previously computed power allocations and scheduling decision on tone n. At first, we keep \hat{p}₂^{[n]}, . . . , \hat{p}_{M}^{[n]} and \hat{k}^{[n]} fixed and we optimize the transmit power \hat{p}₁^{[n]} at base station 1. Then, we use the new value of \hat{p}₁^{[n]} and the previous values of \hat{p}₃^{[n]}, . . . , \hat{p}_{M}^{[n]} and \hat{k}^{[n]} to optimize \hat{p}₂^{[n]} and so on. For each base station m=1, . . . , M, the following one-dimensional search is solved:

$${\hat{p}}_{m}^{[ n ]} = arg {max}_{{p}_{m}^{[ n ]} \geq 0} {g}_{n} ( {p}^{[ n ]} , {\hat{k}}^{[ n ]} , λ ) , \\ s . t . {p}_{j}^{[ n ]} = {\hat{p}}_{j}^{[ n ]} , ∀ j \neq m \qquad ( 17 A )$$

After updating \hat{p}^{[n]}, the scheduling decision on tone n is recomputed as in (7A) and the coordinate ascent search is iterated until convergence. Notice that the coordinate ascent search must converge since at each iteration the value of the objective function is improved.

Step b)—Since g(λ) is a convex function, (13A) can be solved by using any gradient-type search. The main difficulty is that g(λ) may not have a gradient. Luckily, a sub-gradient of g(λ) is given by d=(d₁, . . . , d_{M})^{T}, where

$${d}_{m} ≡ {P}_{m , max} - {\sum }_{n = 1}^{N} {\hat{p}}_{m}^{[ n ]}$$

and \hat{p} is the solution to (15A). Given d, we solve (13A) by using an ellipsoid method.

A solution to (13A) is presented which is based on the ellipsoid method. The idea is to localize the possible set of λ within some initial closed and bounded ellipsoid which contains at least one optimal λ. Then, by evaluating the sub-gradient roughly half of the region is discarded and the process is iterated until convergence. Recall that an ellipsoid with center λ₀ and shape defined by the positive semidefinite matrix λ₀ is defined as

Ellipsoid(A₀,λ₀≡{y:(y−λ₀)^{T}A₀(y−λ₀)≦1}

To choose the initial ellipsoid we need to bound all possible values of λ. Lemma 1: For any given feasible kεK, the optimal set of dual variables \hat{λ} must satisfy

$$0 \leq \frac{{\hat{λ}}_{m}}{{max}_{s ∈ {B}_{m}} {w}_{s}} \leq {\hat{λ}}_{m}^{single} , m = 1 , … , M ,$$

where \hat{λ}ₘ^{single} is the dual variable solving (5A) when only base station m is active and wₛ=1 for sεBₘ.

Implementation issues: Let T₂ be the number of iterations needed for the inner loop (which updates p^{[n]} and \hat{k}^{[n]}) in TABLE IV to converge. For a given value of T₂, the computational complexity of each iteration of the ISB method is O(T₂N(|S|+MN_{gs})), where N_{gs} is the number of points employed to solve (16A) via brute-force grid-search. We remark that ISB has two sources of sub-optimality: 1) for finite N, the duality gap may be non-zero; 2) we only compute a local optimal solution to (16A).

For the special case of K=1, this method reduces to the ISB procedure for ADSL. The user scheduling step and the computation of the initial point for the ellipsoid method are provided.

Successive Convex Approximation for Low-Complexity (SCALE): We leverage the SCALE method derived for ADSL and we extend this procedure to solve (5A). The following bound was derived in the literature:

$$α {log}_{2} z + β \leq {log}_{2} ( 1 + z ) , \\ with \{ \begin{matrix}α = \frac{\overline{z}}{1 + \overline{z}} \\ β = {log}_{2} ( 1 + \overline{z} ) - \frac{\overline{z}}{1 + \overline{z}} {log}_{2} \overline{z}\end{matrix} \qquad ( 18 A )$$

for any z≧0 and z̅≧0. We use the convention that log₂(0)=−∞ and 0 log₂(0)=0.

The bound (18A) is tight at z= z̅. Using (18A) and the transformation \tilde{p}=ln p, we can replace the objective function in (5A) by its lower bound, resulting in the following relaxation which is strictly concave in \tilde{p} for a given k:

$${max}_{{\overline{p}}_{k ∈ K}} {\sum }_{m = 1}^{M} {\sum }_{n = 1}^{N} {w}_{k ( m , n )} [ {α}_{m}^{[ n ]} {\tilde{R}}_{m , k ( m , n )}^{[ n ]} ( {p}^{[ n ]} ) + {β}_{m}^{[ n ]} ] , \\ where \\ s . t . {\sum }_{n = 1}^{N} {e}^{{\overline{p}}_{m}^{[ n ]}} \leq {P}_{m , max} , ∀ m . \qquad ( 19 A )$$

\tilde{R}_{m,s}^{[n]}(\tilde{p}^{[n]})≡log₂└SINR_{m,s}^{[n]}(e ^{p̅[n]})┘ and the constants αₘ^{[n]} and βₘ^{[n]} are computed as specified in (18) for some z̅ₘ^{[n]}≧0.

We now derive an iterative method to solve (19A). Assume that the previous values of {\hat{α}ₘ^{[n]}}, {\hat{β}ₘ^{[n]}} and {\hat{k}(m,n)} are given. We propose to update {\tilde{p}ₘ^{[n]}} as follows:

$$arg {max}_{\overline{p}} {\sum }_{m = 1}^{M} {\sum }_{n = 1}^{N} {w}_{\overline{k} ( m , n )} [ {\hat{α}}_{m}^{[ n ]} {\tilde{R}}_{m , \overline{k} ( m , n )}^{[ n ]} ( {\overline{p}}^{[ n ]} ) + {\hat{β}}_{m}^{[ n ]} ] , \qquad ( 20 A )$$

where (20A) is now

$$s . t . {\sum }_{n = 1}^{N} {e}^{{\tilde{p}}_{m}^{[ n ]}} \leq {P}_{m , max} , ∀ m .$$

a standard convex optimization which is efficiently solved in the dual domain.

E.g., define the Lagrangian function associated with (20A) as

$$\tilde{Λ} ( \tilde{p} , \tilde{λ} ) = {\sum }_{m = 1}^{M} {\sum }_{n = 1}^{N} {w}_{k ( m , n )} [ {α}_{m}^{[ n ]} {\tilde{R}}_{m , k ( m , n )}^{[ n ]} ( {\tilde{p}}^{[ n ]} ) + {β}_{m}^{[ n ]} ] + {\sum }_{m = 1}^{M} {\tilde{λ}}_{m} ( {p}_{m , max} - {\sum }_{n = 1}^{N} {e}^{{\tilde{p}}_{m}^{[ n ]}} ) ,$$

where \tilde{λ}=(\tilde{λ}₁, . . . , \tilde{λ}_{M}) is the vector of non-negative Lagrange multipliers. The corresponding dual problem is

$${min}_{\overline{λ} \geq 0} {max}_{\overline{p}} \tilde{Λ} ( \tilde{p} , \tilde{λ} ) .$$

Given \tilde{λ}, the inner dual maximization is solved by finding the stationary point with respect to \tilde{p}. After some manipulations, we obtain the following system of equations:

$${p}_{m}^{[ n ]} = \frac{{w}_{k ( m , n )} {α}_{m}^{[ n ]}}{{\tilde{λ}}_{m} ln 2 + {\sum }_{j = 1 , j \neq m}^{M} \frac{{w}_{k ( j , n )} {α}_{j}^{[ n ]} {G}_{m , k ( j , n )}^{[ n ]}}{1 + {\sum }_{u = 1 , u \neq j}^{M} {p}_{u}^{[ n ]} {G}_{u , k ( j , n )}^{[ n ]}}} , ∀ m , n .$$

The right hand side is an interference function; therefore, the powers pₘ^{[n]}(τ+1), ∀m,n, can be iteratively updated by substituting pᵤ^{[n]} on the RHS with pᵤ^{[n]}(τ). In practice, we do not have to wait for full convergence and few iterations are sufficient before updating \tilde{λ}.

Given \tilde{p}, \tilde{λ} is updated by using the ellipsoid method as described above. In order to choose an initial ellipsoid, we give the following result. Lemma 2: For any given feasible kεK, the optimal set of dual variables \tilde{λ} must satisfy

$$0 \leq \frac{{\hat{λ}}_{m}}{{max}_{s ∈ {B}_{m}} {w}_{s}} \leq \frac{1}{{p}_{m , max} ln 2} {\sum }_{n = 1}^{N} {α}_{m}^{[ n ]} ≡ {\hat{λ}}_{m}^{single} , m = 1 , … , M ,$$

where \hat{λ}ₘ^{single} is the dual variable solving (20A) when only base station m is active and wₛ=1 for sεBₘ.

Given {\tilde{p}ₘ^{[n]}}, the new scheduling decision {k(m,n)} is computed as in (7A). Finally, notice that in (19A), we are maximizing a lower bound of the weighted system sum-rate. Therefore, it is natural to tighten the bound at each iteration by updating the choice of {αₘ^{[n]}} and {βₘ^{[n]}} according to the new SINR values given by

$${\overline{z}}_{m}^{[ n ]} = \frac{{p}_{m}^{[ n ]} {G}_{m , k ( m , n )}^{[ n ]}}{1 + {\sum }_{j = 1 , j \neq m}^{M} {p}_{j}^{[ n ]} {G}_{m , {k}_{q} ( m , n )}^{[ n ]}} , ∀ m , n . \qquad ( 21 A )$$

The entire method is listed in TABLE V.

Implementation issues: Let T₃ be the number of iterations required to solve (20A) in the dual domain. For a given value of T₃, the computational complexity of SCALE is O(T₃N|S|). This procedure always improves the objective function at each iteration: indeed, the optimization in (20A) is strictly concave and the user selection in (7A) strictly improves the value of the objective function for a given feasible set of powers. Hence, the procedure must converge and the solution obtained at convergence must satisfy (7A), (9A) and (10A).

I-IWF, ISB and SCALE initialization: All previous methods are iterative and, therefore, need to assume some initial power allocation from which they can evolve.

Once the initial power allocation at each coordinated access point is given, the corresponding optimal scheduling decision is unequivocally obtained from (7A). Therefore, giving an initial power allocation is sufficient to specify the starting point of the methods.

For example, an initial random or uniform power allocation across tones may be chosen. However, different starting points may generally converge to a different solution with a different speed; hence, the choice of the starting point is an implementation parameter that could be possibly optimized. In the following, we propose a greedy strategy to initialize I-IWF, ISB and SCALE, which relies on a binary power control concept.

Notice first that the optimal power allocation is rather simple when M=2 and N=1: each of the two base stations has to be either silent or transmitting at full power. For N=1 and M>2, binary power control (i.e., restricting each base station to be either silent or transmitting at full power) is no longer optimal; however, experiments have shown that it still performs reasonably well for a large range of network configurations.

Leveraging these previous results, we propose the following per-tone BPC (PT-BPC) strategy. We define a^{[n]}≡(a₁^{[n]}, . . . , a_{M}^{[n]})^{T} as an activation vector with aₘ^{[n]}=P_{m,max}/N if base station m is active on tone n and aₘ^{[n]}=0 otherwise. Let A be the set containing the 2^{M}−1 possible non-zero values of a^{[n]}. For each tone n=1, . . . , N, we choose the initial power allocation pₛₜₐᵣₜ^{[n]} and the corresponding set of co-channel users kₛₜₐᵣₜ^{[n]} so as to maximize the per-tone weighted sum-rate:

$$\{ {p}_{start}^{[ n ]} , {k}_{start}^{[ N ]} \} = arg {max}_{{{a}^{[ n ]} ∈ A}_{{k}^{[ n ]} ∈ B}} {\sum }_{m = 1}^{M} {w}_{k ( m , n )} {R}_{m , k ( m , n )}^{[ n ]} ( {a}^{[ n ]} ) ,$$

for n=1, . . . , N. (22A)

Remark 1: The above solution is generally sub-optimum for any value of M if N>2. Indeed, equally splitting the available power across tones is arbitrary; also, after tone-by-tone optimization, base stations may not use all of the available power. Despite its suboptimality, the PT-BPC solution in (22A) still provides a reasonably good approximation of the optimal solution to (5A) and we argue that I-IWF, ISB and SCALE all have the potential to improve upon this initial guess by iteratively reallocating and balancing the unused power across tones. The analysis of the impact of the starting point on the performance of I-IWF, ISB and SCALE is presented below.

Remark 2: The exhaustive search in (22A) has a complexity O (|S|2^{M}). Due to synchronization issues and signaling overhead, we expect that only local coordination of few adjacent access points is realistic in near future network evolutions. In this case, the exhaustive search is then feasible. Alternatively, a greedy algorithm can be employed to solve (22A) with a complexity only linear in M at the cost of some performance loss.

REDUCED-FEEDBACK STRATEGIES FOR NETWORK COORDINATION: Implementing the methods described above provides that each access point m collects and forwards to the central controller NMKₘ channel quality measurements. This may not be realistic when K or N is large, since it would need a large bandwidth in the uplink channel. Therefore, more practical solutions are presented.

I-IWF, ISB and SCALE with reduced-feedback (I-IWF-RF, ISB-RF and SCALE-RF): Network signaling significantly reduces if only a small subset of users must report complete channel state information to the central controller. Leveraging this, a greedy two-step procedure may be employed wherein we first collect a limited channel feedback from each active terminal and then, upon making some local scheduling decisions at each access point, we include incremental channel quality measurements only for a limited number of users. In particular, we propose the following.

1) In the first phase, we assume that each user sεBₘ simply reports to the reference access point m a single SINR information for each tone. At this stage, the reported SINR's are computed by assuming a uniform power allocation at each access point, i.e.,

$${\overline{SINR}}_{s}^{[ n ]} = \frac{{P}_{m , max} {G}_{m , s}^{[ n ]}}{N + {\sum }_{j = 1 , j \neq m}^{M} {P}_{j , max} {G}_{j , s}^{[ n ]}} , n = 1 … , N . \qquad ( 23 A )$$

Relying on { S̅I̅N̅R̅ₛ^{[n]}}, each access point m=1, . . . , M independently makes its user selection on each tone according to the following rule:

$$\overline{k} ( m , n ) = arg {max}_{s ∈ {B}_{m}} {w}_{s} {log}_{2} ( 1 + {\overline{SINR}}_{s}^{[ n ]} ) , n = 1 , … , N .$$

2) In the second phase, each access point m requests user k̅(m,n) selected on tone n to provide G_{1, k̅(m,n)}^{[n]}, . . . , G_{M, k̅(m,n)}^{[n]} to the central controller. Notice that, since user k̅(m,n) has already sent back the SINR value in (23), only M−1 additional channel quality measurements need to be sent back.

At this point, the I-IWF (or ISB or SCALE) method discussed above can be run on the selected set of co-channel users { k̅(m,n)} to optimize the power allocation across tones at each coordinated base station. Also, PT-BPC can still be employed to compute an initial power allocation as follows

$$\{ {p}_{start}^{[ n ]} \} = arg {max}_{{a}^{[ n ]} ∈ A} {\sum }_{m = 1}^{M} {w}_{\overline{k} ( m , n )} {R}_{m , \overline{k} ( m , n )}^{[ n ]} ( {a}^{[ n ]} ) , for n = 1 , … , N . \qquad ( 24 )$$

The above two-step procedure requires that each access point m collects only NKₘ+N(M−1) channel quality measurements (NKₘ in the first phase and N(M−1) in the second phase). Therefore, we will refer to it as I-IWF or ISB or SCALE or PT-BPC with reduced feedback, depending on which strategy is employed to optimize the power allocation in the second phase. Finally, notice that the scheduling decisions are now made locally at each access point without coordination, while only the power allocation is jointly computed at the base station controller; hence, both the signaling overhead and the implementation complexity are significantly reduced.

Opportunistic base station selection (OBSS): A simple reduced-feedback method for base station coordination can be derived by imposing to (5A), the additional constraint that at most one access point is active on each tone, i.e., pₘ^{[n]}pₗ^{[n]}=0, if m≠l. In this case, no inter-cell interference is permitted and, therefore, each user sεBₘ estimates and sends back only the normalized channel gain G_{m,s}^{[n]} on each tone.

For large N, a solution (which is optimal in the limit N→∞) can be obtained by using the dual method described above. Alternatively, we propose here the following greedy strategy.

1. Set Dₘ={Ø} and pₘ^{[n]}=P_{m,max}/N form m=1, . . . , M and n=1, . . . , N.

2. For n=1, . . . , N, decide which user and base station can use the channel as follows:

$$\begin{matrix}\hat{k} ( m , n ) = arg {\underbrace{{max}_{s ∈ {B}_{m}} [ {w}_{s} {log}_{2} ( 1 + {p}_{m}^{[ n ]} {G}_{m , s}^{[ n ]} ) ]}}_{{\overline{R}}_{m}^{[ n ]}} , m = 1 , … , M , & ( 25 A ) \\ {D}_{\dot{m}} = {D}_{\dot{m}} ⋃ \{ n \} , where \hat{m} = arg {max}_{p ∈ \{ 1 , … , M \}} {\hat{R}}_{p}^{[ n ]} & ( 26 A )\end{matrix}$$

3. Finally, allocate the power across the active tones by solving the following water-filling system:

$$\{ \begin{matrix}{\hat{p}}_{m}^{[ n ]} = 0 , ∀ n ∉ {D}_{m} , \\ {\hat{p}}_{m}^{[ n ]} = {( \frac{{w}_{\hat{k} ( m , n )}}{λ} - \frac{1}{{G}_{m , \hat{k} ( m , n )}^{[ n ]}} )}^{+} , ∀ n ∈ {D}_{m} , \\ {\sum }_{n ∈ {D}_{m}} {( \frac{{ω}_{\hat{k} ( m , n )}}{λ} - \frac{1}{{G}_{m , \hat{k} ( m , n )}^{[ n ]}} )}^{+} = {P}_{m , max} .\end{matrix} \qquad ( 27 A )$$

While accounting for priorities, the above method opportunistically tries to assign each tone to the user with the best downlink channel among all base stations; therefore, it benefits from an extended multiuser diversity gain. Notice that there are no iterations involved and the implementation complexity is mainly tied to solving the M water-filling problems in (27A) which can be efficiently done via bisection. Finally, we remark that the greedy procedure is optimal when users have equal priorities and, for N=1, reduces to the procedure for a narrowband fading channel.

Sub-carrier grouping: All strategies discussed so far provide that each user sends back to its access point one or more channel quality measurements per tone. On the other hand, adjacent tones are highly correlated; therefore, they can be grouped in P resource blocks, each one including N_{b}=N/P consecutive tones and only a set of channel quality measurements per resource block is fed back. Moreover, per-user feedback may be further reduced by notifying the reference base station the quality of only the best Q (with Q<<p≦N) resource blocks: each user is likely to be scheduled on those tones where a larger throughput can be achieved.

NUMERICAL EXAMPLES: The performance of the present methods is simulated via Monte-Carlo simulations.

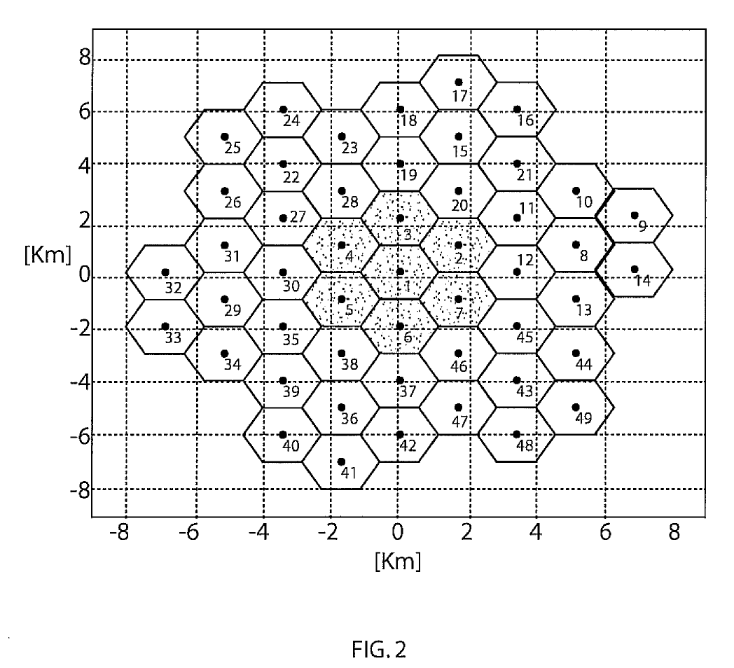

Simulation setup: We consider a cellular OFDMA system with N=16 tones as shown in FIG. 2. A central cluster of M=7 cells is coordinated, while the remaining access points are treated as a source of uncoordinated other-cell interference (OCI). The distance D between adjacent base stations is 2 Km and users are uniformly distributed around the reference access point within a circular sector of an internal and external radius of 500 and 1100 meters, respectively.

We model the base-band fading channel linking the m-th base station to the s-th mobile as a finite impulse response (FIR) filter with L=6 equally spaced taps:

$${h}_{m , s} ( t ) = {\sum }_{l = 0}^{L - 1} {α}_{m , s} ( l ) δ ( t - lt / N ) , m = 1 , … , M , s ∈ S , \qquad ( 28 A )$$

where α_{m,s}(l) is the complex random gain introduced by the l-th path and T is the OFDMA symbol interval. The path gains are independently generated assuming that α_{m,s} (l)=(200/d_{m,s})^{3.5} α̅_{m,s} α̅_{m,s}(l) where d_{m,s} is the distance of user s from base station m; 10 log₁₀ ( α̅_{m,s}) is a real Gaussian random variable with zero mean and variance 10 accounting for large scale shadowing; finally, α̅_{m,s}(l) accounts for Ricean fast fading and is modeled as

$${\overline{α}}_{m , s} ( l ) = \sqrt{\frac{{σ}_{l}^{2}}{2}} {e}^{- j θ} + \sqrt{\frac{{σ}_{l}^{2}}{2}} CN ( 0 , 1 )$$

where θ is a uniform phase in [0, 2π), CN(0, 1) is a standard circularly symmetric complex Gaussian random variable and σ₀², . . . , σ_{L-1}² are given by 0.4, 0.3, 0.1, 0.1, 0.05, 0.05, respectively.

To reduce the number of system variables, we assume P_{m,max}=Pₘₐₓ and Kₘ=K for m=1, . . . , M. Moreover, the noise power Nₛ^{[n]} at each mobile is modeled as follows

$${N}_{s}^{[ n ]} = {σ}^{2} + {\sum }_{s = 8}^{49} {( 200 / {d}_{m , s} )}^{3.5} {\overline{α}}_{m , s} \frac{{P}_{max}}{N Δ} , \qquad ( 29 A )$$

wherein σ² is the thermal noise power (assumed to be the same at each receiver), while the second term on the right hand side accounts for the uncoordinated OCI (we assume here that mobile terminals can only track the long-term interference level from the uncoordinated cells and, hence, the short term fading components are averaged out). The parameter Δ in (29A) controls the transmit power imbalance between the coordinated and the uncoordinated access points. Two relevant cases are discussed: Δ=0 dB (strong uncoordinated OCI) and Δ=60 dB (weak uncoordinated OCI).

In the following, performances are parameterized versus the signal-to-noise ratio (SNR) which is defined as γ≡Pₘₐₓ/σ². Each plot is obtained by averaging the weighed sum-rate over 15 independent random locations of the users; for each location, path loss and shadowing are kept fixed and performance is averaged over 15 independent realizations of the fast fading coefficients. At each run, a set of normalized weights is randomly generated and higher priorities are assigned to the users with larger distance from the reference base station. (This choice is suggested by the fact that, to maintain long-term fairness in practical systems, edge users should have higher priorities than inner terminals to balance the more severe path loss and inter-cell interference.)

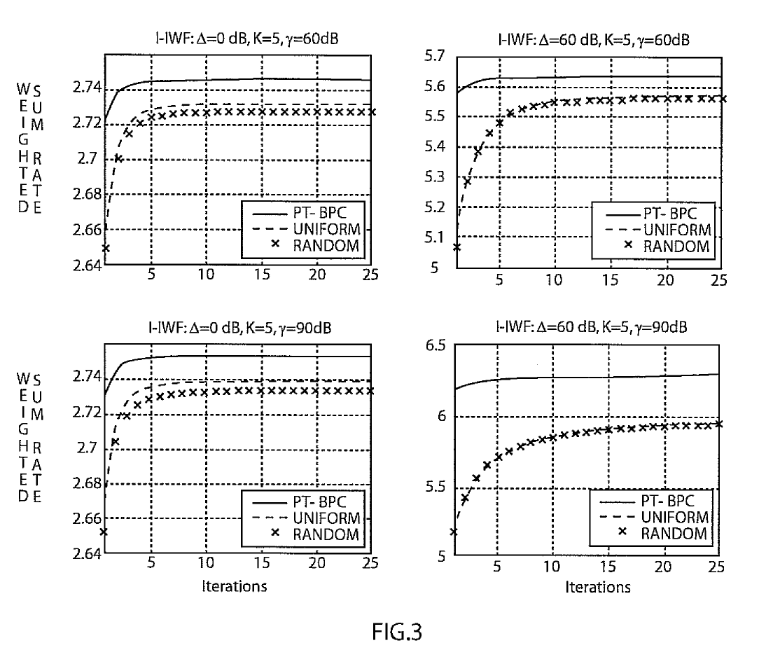

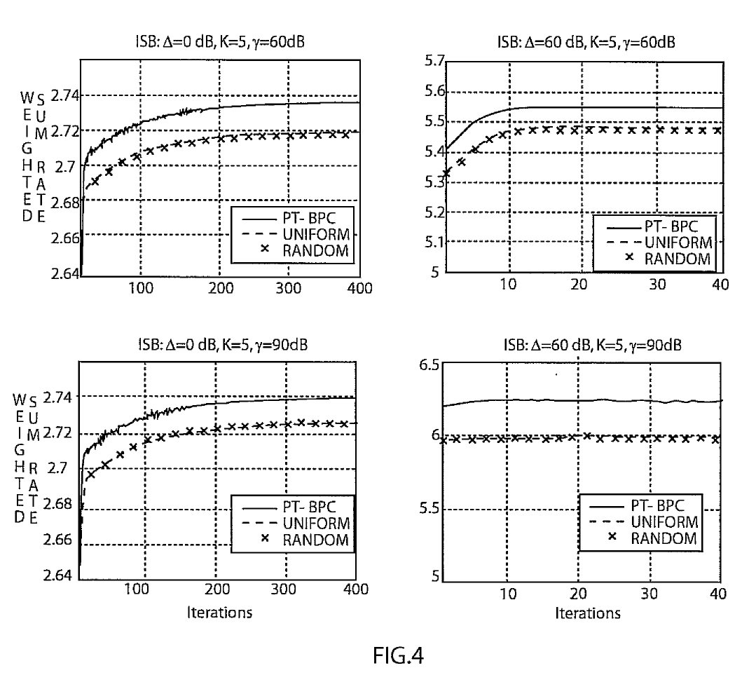

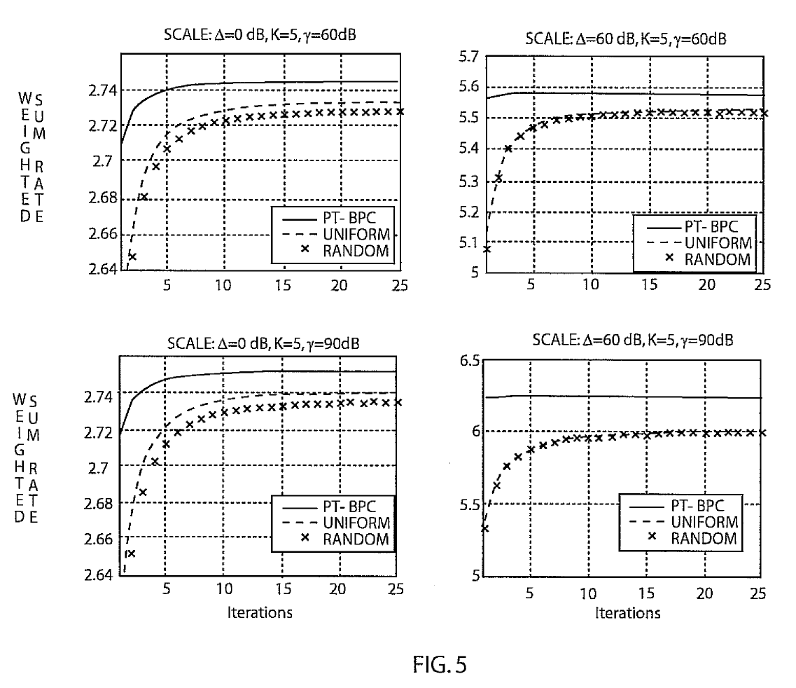

Simulation results: We start by studying the convergence properties of the three proposed iterative methods. In FIGS. 3, 4 and 5, we report the weighted sum-rate versus the number of iterations for I-IWF, ISB and SCALE, respectively. Assuming K=5, four network configurations are considered corresponding to γ=60 or 90 dB and Δ=0 or 60 dB. Three starting points are studied for each iterative method: 1) a random power allocation, 2) a uniform power allocation and 3) the PT-BPC solution in (21). Notice that convergence is always observed for all strategies from any starting point. Convergence has also been observed in our simulations when considering a different number of users, a different operating SNR and a different value of Δ; however, these additional results have been omitted for brevity. As a general trend, all algorithms present a faster convergence speed and a better solution at convergence when the PT-BPC solution is employed as starting point. In this latter case, it is also interesting to notice that 5-20 iterations are mostly sufficient to achieve a significant fraction of the final value at convergence. This latter property suggests that, in practice, we do not have to wait for full convergence, but just few iterations may be sufficient to obtain a reasonably good solution.

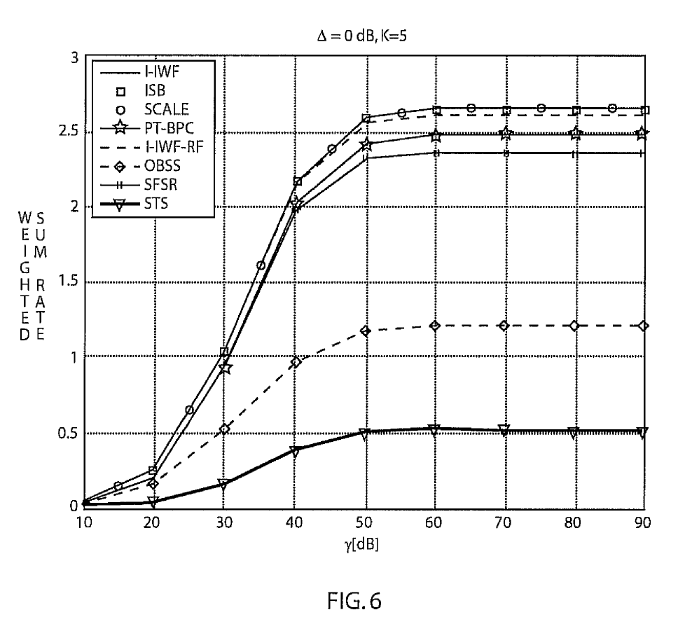

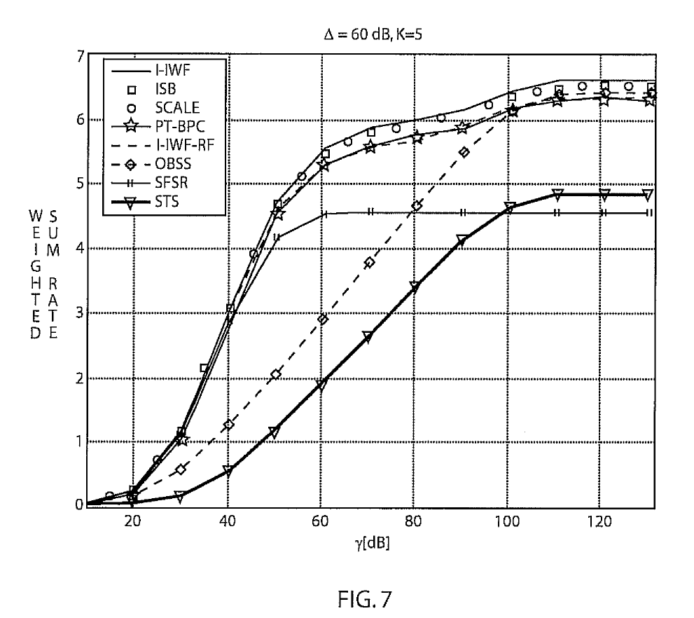

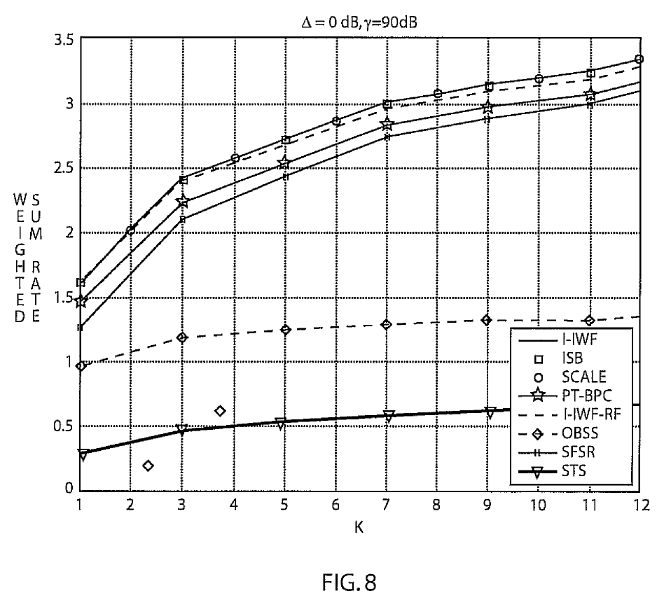

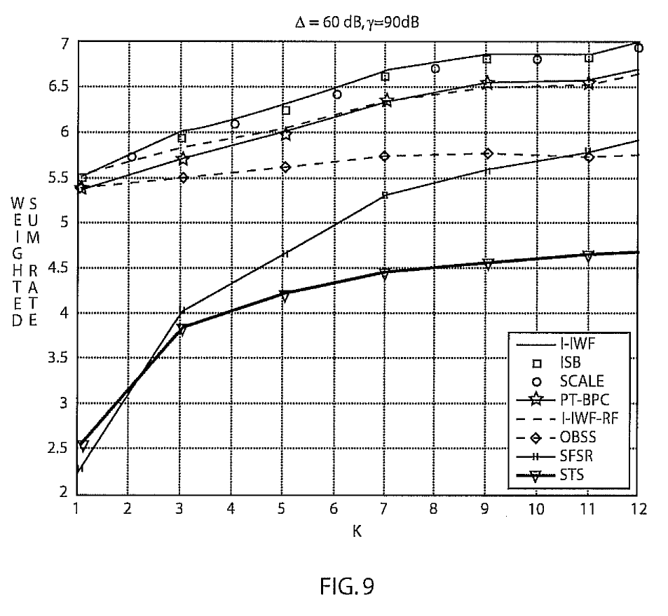

We now investigate the performance of I-IWF, ISB and SCALE at convergence when the PT-BPC solution in (22A) is employed as the starting point. The following stopping criterion is employed to assess convergence: let fₙ be the value of the objective function at iteration n, the method is stopped when |fₙ−fₙ₋₁|<0.01. In FIGS. 6 and 7, we plot the weighted sum-rate versus γ for K=5 and Δ=0 and 60 dB, respectively; in FIGS. 8 and 9, instead, we show the weighted sum-rate versus K for γ=90 dB and Δ=0 and 60 dB, respectively. For the sake of comparison, we also report in each plot the performance corresponding to:
the PT-BPC solution {pₛₜₐᵣₜ^{[n]}, kₛₜₐᵣₜ^{[n]}} in (22A)
the I-IWF-RF method with (24A) employed as initial power allocation;
the OBSS algorithm;
a static full spectral reuse (SFSR) strategy, wherein base stations equally split the power across tones and use the same spectrum with no coordination;
a static time-sharing (STS) strategy, wherein base stations avoid inter-cell interference by using the entire spectrum one at the time and optimally split the power across tones.

Notice that the last two strategies require no coordination and information sharing among base stations and, therefore, they provide a lower benchmark for the performance of all other methods.

As to I-IWF, ISB and SCALE, they all improve upon the initial solution in all operating conditions. At low SNR's, equally splitting the power across tones is not optimal: hence, I-IWF, ISB and SCALE improve throughput by iteratively balancing the power across tones based on the link qualities. At medium/high SNR's the system becomes interference limited and PT-BPC mostly decides to avoid simultaneous transmission by switching off some base stations. In this case, I-IWF, ISB and SCALE improve throughput by intelligently reallocating the unused power across tones. For the same initialization point, I-IWF, ISB and SCALE all provide a similar throughput performance at any value of y and K and outperform all the other strategies.

In practical systems, we would like to choose the method which is easiest to implement. A fair and rigorous complexity comparison is not easy to provide, since it requires computing the expected number of operations performed by each algorithm which is still an open problem. However, FIGS. 3, 4 and 5 suggest that SCALE and I-IWF converge faster than ISB over a wide range of operating conditions and thus they might be preferred.

As to I-IWF-RF, we emphasize that it achieves a weighted sum-rate close to that of I-IWF over a wide range of operating conditions. This is extremely attractive since I-IWF-RF needs significantly less feedback and signaling overhead than I-IWF. A similar performance is also achieved by ISB-RF and SCALE-RF; however, results are omitted for brevity.

As to OBSS, this strategy significantly improves performance with respect to STS since an extended multiuser diversity is exploited, but it is usually inferior to the other strategies. In particular, notice that OBSS can outperform SFSR only when the uncoordinated OCI is negligible and y is sufficiently large; indeed, in this operating regime the weighted sum-rate is limited by the interference caused by the M coordinated access points; hence, turning on all base stations without any power control is harmful.

Finally, it is seen that increasing the number of users per cell has beneficial effects on all strategies. This is due to the fact that increasing K improves the multiuser diversity gain.

Numerical results have shown that I-IWF, ISB and SCALE (and their reduced feedback versions) all provide significant performance gain with respect uncoordinated transmission strategies gains by judicially optimizing power and user selection across tones. I-IWF and SCALE may be preferred to ISB since in the present examples they showed better convergence properties over a wide range of operating conditions.

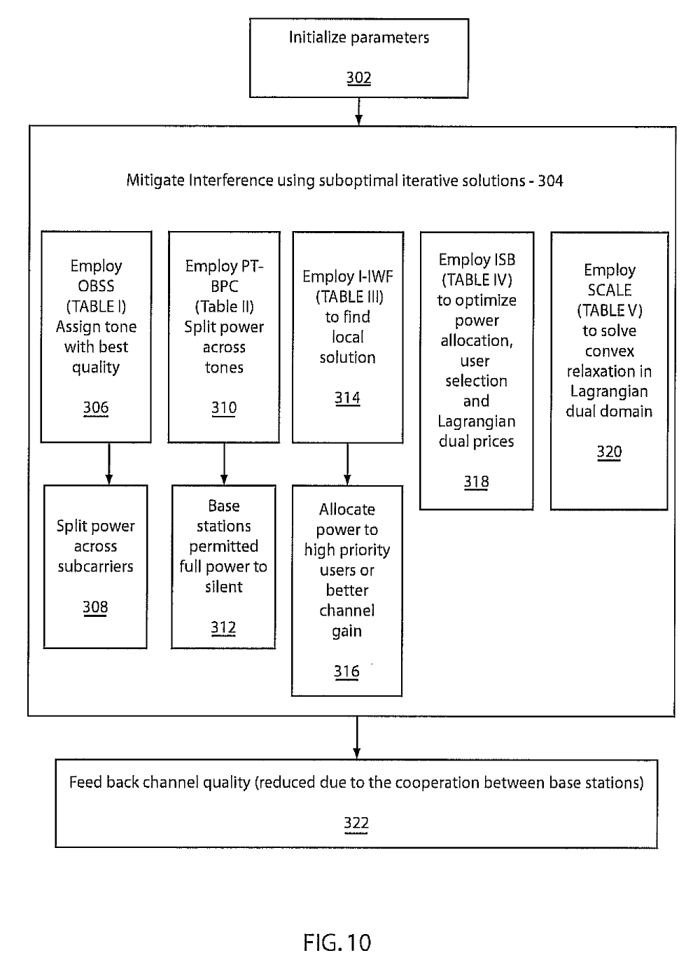

Referring to FIG. 10, a block/flow diagram for a general system/method for implementing co-channel interference mitigation in a multi-cell Orthogonal Frequency-Division Multiple Access (OFDMA) based wireless system with full spectral reuse in accordance with the present principles is illustratively shown. In block 302, parameters are initialized for an objective function that describes a system with a plurality of base stations configured to handle communications with mobile units. This initialization may include a plurality of different techniques depending on the method employed. The parameter initiated includes an initial power allocation, number of tones, counters, weights and coefficients, scheduling parameters, etc. in accordance with TABLES I-VI.

In block 304, interference is mitigated between the plurality of base stations via jointly optimizing coordinated scheduling and power allocation in accordance with a sub-optimal iterative solution. Sub-optimal refers to employing a premature optimization. For example, rather than converging to an optimal result a local optimum may be employed or a result after a few iterations may be employed to move in the direction of an optimal solution. Joint optimization is provided by employing one or more of the methods provided in TABLES I-VI. For example, the sub-optimal iterative solution includes an opportunistic base station selection (OBSS) solution such that while accounting for a priority of users, assigning each tone to a user with a best channel quality among all base stations in block 306. After per-tone user selection, each base station splits an available power across a set of active subcarriers in block 308.

The sub-optimal iterative solution may includes per-tone binary power control (PT-BPC) to equally split available power across tones in block 310. Each base station is permitted to be either silent or transmitting at full power on each tone in block 312.

The sub-optimal iterative solution may include improved iterative water-filling (I-IWF) to find a local optimal solution by iteratively solving a Karush-Kuhn-Tucker (KKT) system in block 314. More power is allocated on tones which serve users with either higher priority or better channel gains in block 316.

The sub-optimal iterative solution may include iterative spectrum balancing (ISB) which employs a Lagrange dual domain by iteratively optimizing power allocation, user selection and Lagrangian dual prices in block 318.

The sub-optimal iterative solution may include successive convex approximation for low-complexity (SCALE) to iteratively solve a convex relaxation in a Lagrange dual domain in block 320.

In block 322, feed back of at least one channel quality measurement per resource block is preferably provided. This feed back can be reduced such that only a subset of users is requested to report full channel state information. This is enabled as a result of the cooperation/coordination between base stations provided in accordance with the present principles.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A multi-cell Orthogonal Frequency-Division Multiple Access (OFDMA) based wireless system with full spectral reuse and co-channel interference mitigation via base station coordination in a downlink channel, comprising:
a plurality of base stations configured to handle communications with mobile units;
a central controller configured to mitigate interference between base stations via jointly optimizing coordinated scheduling and power allocation in accordance with a sub-optimal iterative solution.

2. The system as recited in claim 1, wherein the sub-optimal iterative solution includes an opportunistic base station selection (OBSS) solution such that while accounting for a priority of users, assigning each tone to a user with a best channel quality among all base stations.

3. The system as recited in claim 2, wherein after per-tone user selection, each base station splits an available power across a set of active subcarriers.

4. The system as recited in claim 1, wherein the sub-optimal iterative solution includes per-tone binary power control (PT-BPC) to equally split available power across tones.

5. The system as recited in claim 4, wherein each base station is permitted to be either silent or transmitting at full power on each tone.

6. The system as recited in claim 1, wherein the sub-optimal iterative solution includes improved iterative water-filling (I-IWF) to finds a local optimal solution by iteratively solving a Karush-Kuhn-Tucker (KKT) system.

7. The system as recited in claim 6, wherein more power is allocated on tones which serve users with either higher priority or better channel gains.

8. The system as recited in claim 1, wherein the sub-optimal iterative solution includes iterative spectrum balancing (ISB) which employs a Lagrange dual domain by iteratively optimizing power allocation, user selection and Lagrangian dual prices.

9. The system as recited in claim 1, wherein the sub-optimal iterative solution includes successive convex approximation for low-complexity (SCALE) to iteratively solves a convex relaxation in a Lagrange dual domain.

10. A method for co-channel interference mitigation in a multi-cell Orthogonal Frequency-Division Multiple Access (OFDMA) based wireless system with full spectral reuse, comprising:
initializing parameters for an objective function that describes a system with a plurality of base stations configured to handle communications with mobile units; and
mitigating interference between the plurality of base stations via jointly optimizing coordinated scheduling and power allocation in accordance with a sub-optimal iterative solution.

11. The method as recited in claim 10, wherein the sub-optimal iterative solution includes an opportunistic base station selection (OBSS) solution such that while accounting for a priority of users, assigning each tone to a user with a best channel quality among all base stations.

12. The method as recited in claim 11, wherein after per-tone user selection, each base station splits an available power across a set of active subcarriers.

13. The method as recited in claim 10, wherein the sub-optimal iterative solution includes per-tone binary power control (PT-EPC) to equally split available power across tones.

14. The method as recited in claim 13, wherein each base station is permitted to be either silent or transmitting at full power on each tone.

15. The method as recited in claim 10, wherein the sub-optimal iterative solution includes improved iterative water-filling (I-IWF) to finds a local optimal solution by iteratively solving a Karush-Kuhn-Tucker (KKT) system

16. The method as recited in claim 15, wherein more power is allocated on tones which serve users with either higher priority or better channel gains.

17. The method as recited in claim 10, wherein the sub-optimal iterative solution includes iterative spectrum balancing (ISE) which employs a Lagrange dual domain by iteratively optimizing power allocation, user selection and Lagrangian dual prices.

18. The method as recited in claim 10, wherein the sub-optimal iterative solution includes successive convex approximation for low-complexity (SCALE) to iteratively solves a convex relaxation in a Lagrange dual domain.

19. The method as recited in claim 10, further comprising feeding back at least one channel quality measurement per resource block.

20. The method as recited in claim 10, further comprising reducing feed back such that only a subset of users is requested to report full channel state information.

21. A computer readable medium comprising a computer readable program, wherein the computer readable program when executed on a computer causes the computer to perform the steps of claim 10.
